(19) United States
(12) Patent Application Publication
(10) Pub. No.: US 2003/0207190 A1
(43) Pub. Date: Nov. 6, 2003

(54) Electrophotographic toner and image forming method

(75) Inventors: Yasushige Nakamura, Kawasaki (JP); Toru Takahashi, Kawasaki (JP)

Correspondence Address: ARMSTRONG,WESTERMAN & HATTORI, LLP, 1725 K STREET, NW, SUITE 1000, WASHINGTON, DC, 20006, US

(73) Assignee: Fujitsu Limited, Kawasaki (JP)

(21) Appl. No.: 09/968,040

(22) Filed: Oct. 2, 2001

Related U.S. Application Data
(63) Continuation of application No. PCT/JP99/01825, filed on Apr. 6, 1999.

(51) Int. Cl. G03G 9/08

(52) U.S. Cl. 430/108.1; 430/124

(57) ABSTRACT

Disclosed is an electrophotographic toner which comprises a bisphenol A monomer. The toner may be either a magnetic toner or a non-magnetic toner, and the developing method using the toner may be either a single-component developing method or a two-component developing method. Moreover, the toner can be used commonly with both the flash fixing system and the heat roll fixing system and significantly improves the fixing strength without accompanying any prior art problem such as formation of voids during fixing.

### CROSS-REFERENCE TO RELATED APPLICATIONS

This application is a continuation of PCT/JP99/01825, filed on Apr. 6, 1999, the contents being incorporated herein by reference.

### TECHNICAL FIELD

The present invention relates to an electrophotographic toner and, more particularly, to an electrophotographic toner which can be used commonly with both the flash fixing system and the heat roll fixing system, in other words, an electrophotographic toner which does not require selection of a fixing system in the toner fixing step. The present invention also relates to an image forming method which employs the electrophotographic toner. The electrophotographic toner of the present invention can be used advantageously as a developing agent in various imaging apparatuses employing the electrophotographic system, for example, an electrophotographic copying machine, an electrophotographic facsimile, an electrophotographic printer and an electrostatic printing machine.

### BACKGROUND ART

Operation of the electrophotographic system which has been widely used in copying machines, printers and printing machines generally begins by charging the surface of a photoconductive insulator such as a photosensitive drum uniformly with a positive or negative electrostatic charge. After charging uniformly, the electrostatic charge on the insulating material is partially erased by irradiating the photoconductive insulator with image light by various means thereby to form an electrostatic latent image. For example, an electrostatic latent image corresponding to image information can be formed on the photoconductive insulator by erasing the surface charge from particular portions by irradiating with a laser beam. Then a fine powder of developing agent referred to as toner is deposited on the latent image where the electrostatic charge remains on the photoconductive insulator, thereby to visualize the latent image. Last, in order to print the toner image obtained as described above, it is common to electrostatically transfer the image onto a recording medium such as recording paper. Then, the transferred image is melted and fixed by application of heat, light, pressure or the like.

The fixation of the transferred images in the final step of the electrophotography method has been implemented using various methods and apparatuses, as is well known. Current systems include the flash fixing system which melts and fixes the toner by irradiating it with light such as flashlight, and the heat roll fixing system which applies pressure to the toner by means of heated fixing roller thereby to melt and fix the toner.

The flash fixing system has advantages such as that the toner can be fixed on a recording medium without making contact because the toner is melted by exposure to light, and therefore curling of the recording paper and offset are eliminated, although the flash lamp used as the light source is expensive. This system also makes it possible to increase the process speed and is applicable to the fixation of images on recording paper which has glue applied to the image fixing surface, such as sealed post card. There is also another merit in that images can be fixed on paper of different thickness with flashlight of the same energy. The flash fixing system having many advantages as described above is preferably employed in high-speed printers for business use and high-speed copying machines. However, the flash fixing system has a problem in that white defects (formation of unprinted area due to lack of application of toner) called voids may occur in the case where the toner used is easy to melt by heating.

White defects experienced in the flash fixing system are caused by a sudden decrease in the viscoelasticity of the toner as it is melted by the light energy applied thereto. Viscoelasticity of the toner usually varies significantly depending on the properties of the binder resin contained in the toner and the melting temperature. In the case where the surface tension of the toner is greater than its viscoelasticity when the toner is melted and fixed, the toner contracts and a part of the toner is pulled out of a portion of the image where the toner should be fixed. When the fixed image includes portions devoid of toner, the portions appear to be white, thus resulting in white defects with decreased image density.

On the other hand, the heat roll fixing system is effective to lower the price of the apparatus, since the recording paper is guided between at least a pair of fixing rollers heated to a high temperature, and which apply heat and pressure directly to the toner image. Further, this system makes the surface having the fixed toner smoother, and prevents diffuse reflection of light from occurring on the surface. Thus, the heat roll fixing system has an advantage such that a wide range of color reproduction can be ensured when a toner is used. To sum up, the heat roll fixing system can exhibit its high performance in the fixing of natural images, thereby enabling to obtain high-quality pictures. However, the heat roll fixing system has problems such as that the paper tends to curl after fixing and also tends to be stained by the toner on the fixing roll due to offset. Moreover, it is difficult to achieve high speed operation with this system due to curling of the paper. Moreover, it has been known in this system that the toner is difficult to fix on a sealed post card or the like.

Furthermore, there is a drawback in that an electrophotographic printer which employs the flash fixing system or one which employs the heat roll fixing system requires use different toners appropriate for the type of apparatus and fixing system. This is because different types of apparatus require use of toner having different fixing characteristics for the particular fixing system. Therefore, in the prior art, it was necessary to manufacture different toners for different fixing systems. Due to increase it variety of toners, it was impossible to reduce the cost of the toner, because mass production cannot be applied.

In addition, a printer which has a combination of the flash fixing system and the heat roll fixing system in order to capitalize on the advantages of both fixing systems has been proposed. However, such a printer requires an additional mechanism for switching the toner feed line according to the fixing system selected, thus making the apparatus and the operation thereof more complicated. In view of this situation, there is demand for an electrophotographic toner which can be used commonly with both the flash fixing system and the heat roll fixing system.

### DISCLOSURE OF THE INVENTION

One object of the present invention is therefore to solve the technical problems of the prior art described above, thereby providing an improved electrophotographic toner which can be used commonly with both the flash fixing system and the heat roll fixing system and significantly improve the fixing strength while preventing occurrence of white defects, called voids, and does not cause such problems as curling of the paper after fixing and staining of the paper by offset.

Another object of the invention is to provide an image forming method which uses the electrophotographic toner of the present invention.

The objects described above and other objects of the present invention will become apparent from the following detailed description.

In one aspect thereof, the present invention resides in an electrophotographic toner which comprises a bisphenol A monomer.

In another aspect thereof, the present invention resides in a method of forming an image on a recording medium by means of an electrophotographic system, which comprises the steps of forming an electrostatic latent image by image exposure, visualizing the electrostatic latent image by development, transferring the visualized image onto the recording medium and fixing the transferred image, wherein

a developing agent containing an electrophotographic toner, which comprises a bisphenol A monomer, is used in the developing step of the electrostatic latent image, and

either a flash fixing system or a heat roll fixing system is used as the toner fixing method in the step of fixing the image after transferring the image, which has been visualized by the use of the developing agent, onto the recording medium.

### BRIEF DESCRIPTION OF THE INVENTION

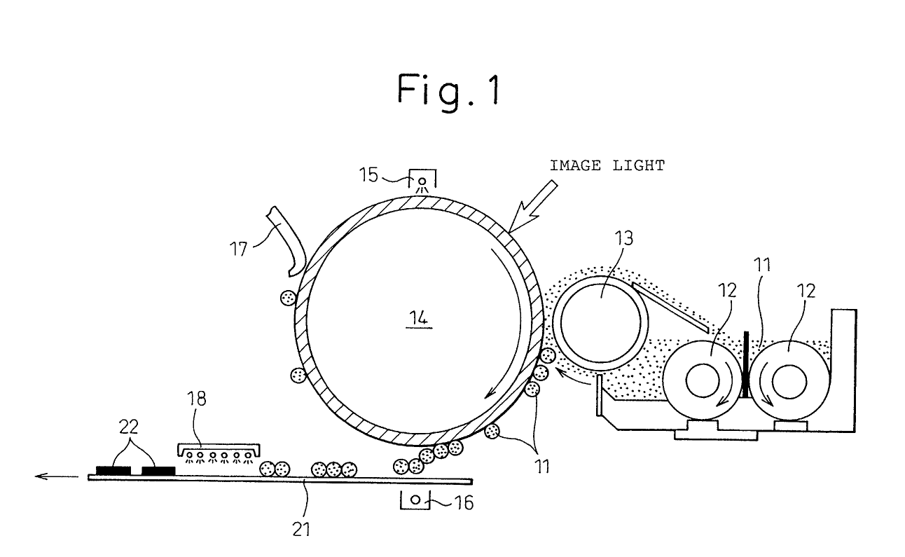

FIG. 1 is sectional view schematically showing an example of an electrophotographic apparatus preferably employed for carrying out the image forming method which uses the flash fixing system as the toner fixing method according to the present invention;

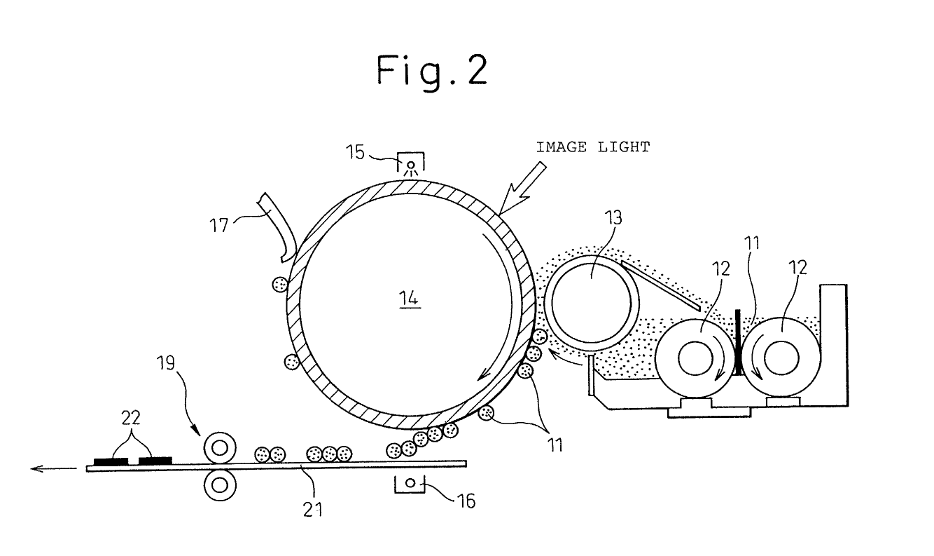

FIG. 2 is sectional view schematically showing an example of an electrophotography apparatus preferably employed for carrying out the image forming method which uses the heat roll fixing system as the toner fixing method according to the present invention;

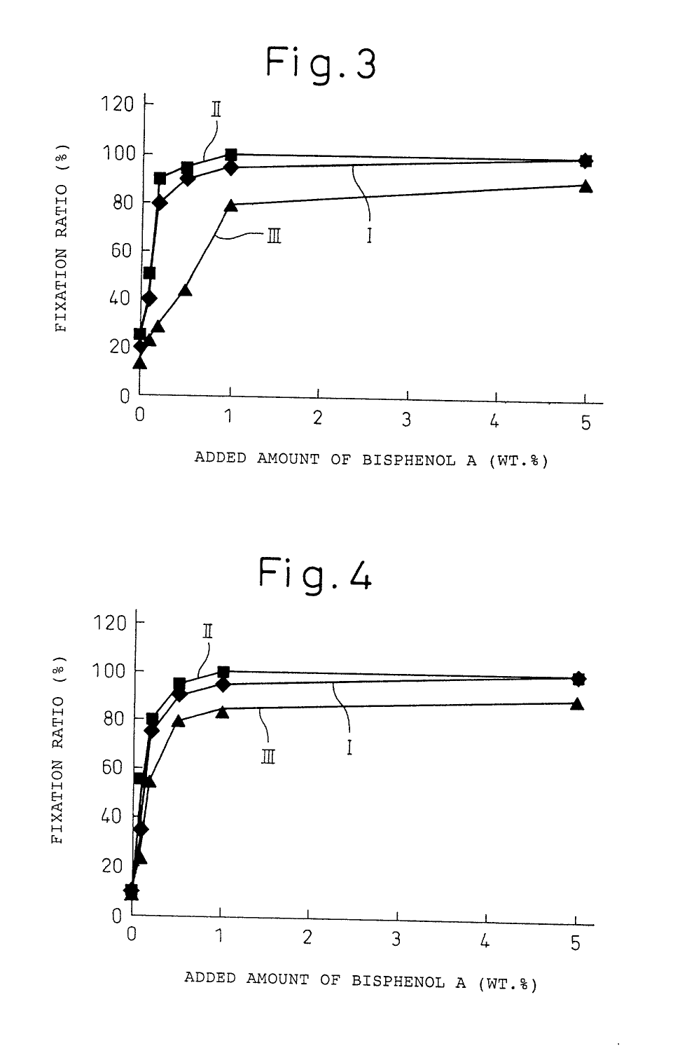

FIG. 3 is a graph showing the toner fixing ratio (%) as a function of the added amount (% by weight) of bisphenol A monomer determined in the printing test (evaluation of flash fixing) of Example 4; and

FIG. 4 is a graph showing the toner fixing ratio (%) as a function of the added amount (% by weight) of bisphenol A monomer determined in the printing test (evaluation of heat roll fixing) of Example 5.

### BEST MODE FOR CARRYING OUT THE INVENTION

The present inventors have conducted intensive studies in relation to a toner which can be used commonly with both the flash fixing system and the heat roll fixing system, and have found that the addition of bisphenol A in the form of a monomer to an electrophotographic toner makes it possible to obtain a toner which can be used commonly with both the flash fixing system and the heat roll fixing system, and also does not have drawbacks peculiar to each system, and that the use of the toner in an electrophotographic printer equipped with a flash fixing mechanism and a heat roll fixing mechanism makes it possible to realize an image forming method which utilizes the advantages of both fixation systems. That is, the present invention is characterized in an improvement in the following fixing step realized as a result of improving the toner used in the preparation of the developing agent in the electrophotographic process.

In the practice of the present invention, the electrophotographic process may be a general one as described in the “BACKGROUND ART”, and is not limited to a specific electrophotographic process. There is also no limitation to the developing method used in the electrophotographic process wherein the present invention is applied, and a proper developing method can be freely selected and employed for each application. In other words, according to the present invention, a developing agent most suitable for the developing method to be employed can be prepared and used for the particular application, while satisfying the requirements of the toner of the present invention. Developing methods which can be employed in the present invention include both a two-component developing system and a one-component developing system that are widely used in the art.

In the two-component developing system, toner particles and carrier particles which comprise magnetite, ferrite, iron powder, glass beads or such particles coated with a resin, are brought into contact with each other, with the toner being caused to deposit on the carrier particles by the use of friction charging, and the toner is then guided to a latent image site thereby to develop the image. In this system, a developing agent is constituted by using the toner in combination with the carrier. Methods employed in this system include magnetic brush development method.

The one-component developing system is also well known, being a variation of the two-component developing system wherein use of the carrier is eliminated. This method eliminates the need for mechanisms such as for toner concentration control, and mixing and stirring, because a carrier is not used, and also makes it possible to reduce the apparatus size. In the one-component developing system, a thin uniform film of toner is formed on a developing roller which is made of metal and an image is developed by attracting the toner to a portion of a latent image. The toner particles deposited on the developing roller can be electrostatically charged by friction charging or electrostatic induction. In the case of a one-component developing system employing friction charging, for example, a magnetic toner is used in a BMT system or FEED system which involve contact, and nonmagnetic toner is used in a touchdown system which involves contact. Details on the electrophotographic processes and the developing methods employed therein should be referred to many publications dealing with the electrophotographic system.

The electrophotographic toner of the present invention may have a composition similar to that of the toner used in the electrophotographic system of the prior art. More precisely, the toner of the present invention may be generally constituted so as to include at least a binder resin, a colorant and an infrared absorber, regardless of the formation of the monochromic or color images. According to the present invention, a predetermined amount of a bisphenol A monomer is additionally added to the toner. While various developing methods are employed in the electrophotographic system as described above, the toner of the present invention may be either a magnetic toner, made of a magnetic material, or a nonmagnetic toner, depending on the developing method employed in the intended electrophotographic processes.

The toner of the present invention can be prepared in the form of spherical fine powder having preferably an average particle diameter within a range from about 0.5 to 50 μm, more preferably from about 1 to 15 μm, by dispersing a colorant, a charge controlling agent and wax in a binder resin made of a natural or synthetic polymer substance, grinding the resulting dispersion material and classifying in size. In the case of the two-component developing agent, after dispersion of the colorant in the binder resin, the resulting fine toner powder is mixed with a carrier substance (carrier) such as iron powder, ferrite powder or the like to form a developing agent which can be used to visualize an electrostatic latent image.

To describe in more detail, the binder resin used in the electrophotographic toner of the present invention is not specifically limited, insofar as the above-mentioned physical properties can be obtained in the toner, and includes conventional binder resins. Suitable examples of the binder resin include styrene-acrylic resin, polyester resin, styrene resin, acrylic resin, phenol resin, silicone resin, and epoxy resin. In the toner of the present invention, it is the most preferred to use a styrene-acrylic resin or a polyester resin as the binder resin. These binder resins may be used alone, or two or more resins may be used in combination or in the form of a composite. A linear polyester resin and a polyester resin containing a crosslinking component may be used in combination.

The colorant to be dispersed in the binder resin includes various well-known dyes and pigments and can be arbitrarily selected and used. Suitable examples of the colorant include black pigments such as various carbon blacks (e.g. channel black, furnace black, etc.); and color pigments such as yellow pigment (e.g. benzidine pigment, etc.), magenta pigment (e.g. quinacridon pigment, rhodamine pigment, etc.) and cyan pigment (e.g. phthalocyanin pigment, etc.). These colorants may be used alone or in combination to obtain a desired toner color.

The content of the colorant in the toner can vary according to the desired results, but is preferably within a range from 2 to 25% by weight in view of the coloring force of printing, shape retention of the toner and scattering of the toner in order to obtain the best toner characteristics.

As described above, it is essential to use a bisphenol A monomer, in addition to the binder resin and the colorant, in the electrophotographic toner of the present invention. Although the present inventors have conducted intensive studies on the possibility of using various compounds, based on their functions and effects, to solve the problems described above, unsatisfactory results were obtained in all of the tested compounds. However, it was found, surprisingly, that only a specific organic compound, bisphenol A monomer, is effective to solve the above problems. Although the detailed reason has not yet been clarified, bisphenol A is effective only when it is used in the form of a monomer, among its various compounds such as derivatives, polymers or the like. It should be understood that the bisphenol A monomer functions as a fixing auxiliary in the toner of the present invention.

The toner preferably contains a bisphenol A monomer in the amount of at least 0.2% by weight, and more preferably within a range from 0.2 to 90% by weight, based on the total amount of the toner. When the amount of the bisphenol A monomer is less than 0.2% by weight, an expected addition effect can not be obtained. On the other hand, when the amount is greater than 90% by weight, it becomes impossible to sufficiently disperse the colorant, the charge controlling agent and the wax added therein and thus the resulting mixture cannot be used as a toner. These drawbacks are drastic when employing the flash fixing system as the toner fixing system. When employing the heat roll fixing system as the toner fixing system, the upper limitation of the amount of the bisphenol A monomer is preferably 50% by weight. When the amount of the bisphenol A monomer is greater than 50% by weight, offset is caused by staining of the heat roll, and therefore the resulting mixture cannot be used as a toner.

In the practice of the present invention, when using the flash fixing system in the step of fixing after the image visualized by using the developing agent is transferred onto the recording medium, the toner constituting the developing agent preferably contains the bisphenol A monomer in an amount within a range from 0.2 to 90% by weight, based on the total amount of the toner. When using the flash fixing system, flash fixing is preferably carried out with the energy of flashlight being set within a range from 0.5 to 3.0 J/cm² and the duration of the flashlight being set within a range from 500 to 3,000 μ/s. When the energy of flashlight and its duration are lower than the above range, the toner cannot be melted sufficiently to increase the flash fixation ratio. On the other hand, when the energy and duration of the flashlight are above than the above range, sufficient void resistance (white defect resistance) and fixing strength can be obtained simultaneously by using a toner containing 0.2 to 90% by weight of the bisphenol A monomer under these flash fixation conditions, as described above. Appropriate flashlight can be selected from light having a wide wavelength ranging from visible light to near infrared light, according to the design of the flash fixing device.

When using the heat roll fixing system as the toner fixing system, the toner constituting the developing agent preferably contains the bisphenol A monomer in an amount within a range from 0.2 to 50% by weight, based on the total amount of the toner. The temperature of the heat roll surface is adjusted to be, in average, the same as or higher than the melting point of the bisphenol A monomer, and more preferably higher than the melting point thereof. When the surface temperature of the heat roll is lower than the melting point of the bisphenol A monomer, the toner cannot be melted sufficiently to increase the heat roll fixation ratio. Sufficient anti-offset properties and fixing strength can be simultaneously obtained by using toner containing 0.2 to 50% by weight of the bisphenol A monomer under these heat roll fixing conditions. Since the melting point of the bisphenol A monomer is usually within a range from about 155 to 160° C., a roll surface temperature of about 160 to 250° C. can be advantageously used.

The electrophotographic toner of the present invention may contain charge controlling agents, which are commonly used in this technical field, for the purpose of controlling the chargeability of the toner. Suitable examples of the charge controlling agent include an electron donative substance such as nigrosine dye, fatty acid metal salt, quaternary ammonium salt or the like in the case of a positively charged toner, or an electron acceptive substance such as azo metal-containing dye, chlorinated paraffin, chlorinated polyester or the like in the case of a negatively charged toner.

In the case where the toner image is fixed by the heat roll fixing system, various waxes such as lower-molecular weight polypropylene or polyethylene can be used as the releasant or anti-offset agent.

For the purpose of improving the fluidity of the toner or for other purposes, hydrophobic silica or titanium oxide may be used as an external additive. In the present invention, other commonly used inorganic particles and resin particles may be externally added, in addition to hydrophobic silica or titanium oxide, if necessary.

The toner components described above can be used by widely varying the ratio according to the composition of a conventionally used toner. For example, the toner components can be used in the following ratio based on the total amount of the toner.

| | |
|---|---|
| Binder resin | 60 to 90% by weight |
| Colorant | 2 to 25% by weight |
| Fixing auxiliary (bisphenol A monomer) | 0.2 to 90% by weight |
| Charge controlling agent | 1 to 5% by weight |
| Releasant | 0 to 5% by weight |
| External additive | 0 to 5% by weight |

If necessary, the toner components each may be used in an amount larger or smaller than the above range.

The electrophotographic toner of the present invention can be prepared according to various procedures using the toner components described above as the starting materials. For example, the toner of the present invention can be made by employing a well-known method such as mechanical grinding and classifying process where resin blocks with a colorant or the like dispersed therein are ground and the resulting particles are classified to obtain the desired one, or a polymerization method where a monomer is polymerized while mixing a colorant or the like therein, thereby forming fine particles. The toner of the present invention is preferably made by the mechanical grinding method, advantageously in a procedure as described below.

(1) Mixing of Starting Materials

A binder resin, a colorant, a charge controlling agent and the like are weighed and mixed uniformly in a powder mixing machine. For the powder mixing machine, for example, a ball mill or the like can be used. The colorant, the charge controlling agent, etc. are dispersed uniformly in the resin binder.

(2) Melt Kneading

The mixture thus obtained is heated to melt and kneaded, by using a screw extruder (extruder), roll mill, kneader or the like. The colorant particles are made into fine particles and dispersed uniformly.

(3) Solidification with Cooling

After the completion of the kneading, the kneaded mixture is solidified with cooling.

(4) Grinding

The solidified mixture is first ground into coarse particles with a coarse grinder such as a hammer mill or cutter mill, and then ground into fine powder with a finer grinder such as a jet mill.

(5) Classification

The fine powder obtained upon fine grinding is classified so as to remove particles which are too small and result in lower fluidity of the toner and scattering of it, and particles which are too large and would result in degradation of picture quality. For example, wind classifier that utilizes centrifugal force may be used as a classification apparatus to obtain the desired spherical fine toner particles.

(6) Surface Treatment

In the last step, the toner particles may be coated with hydrophobic silica or titanium oxide, with another additive added as required, for the purpose of improving the fluidity of the toner. A high speed flow mixer may be used in the surface treatment.

Using the electrophotographic toner of the present invention, images can be formed by conventionally used procedures and apparatuses.

The image forming method, based on electrophotography, of the present invention includes the steps of forming an electrostatic latent image by image exposure, visualizing the electrostatic latent image by development, transferring the visualized image onto the recording medium and fixing the transferred image, as described previously, and is characterized in that:

(1) a developing agent containing an electrophotographic toner, which comprises a bisphenol A monomer, is used in the developing step of the electrostatic latent image, and

(2) either a flash fixing system or a heat roll fixing system is used as the toner fixing method in the step of fixing the image after transferring the image, which has been visualized by the use of the developing agent, onto the recording medium. As described previously, the content of the bisphenol A monomer in the toner used is preferably at least 0.2% by weight, the binder is preferably a styrene-acrylic resin, a polyester resin or a mixture thereof, and the flash fixation and heat roll fixation respectively is carried out under the specific preferred conditions.

The image forming method of the present invention can be carried out similarly to the image forming method of the prior art, except for using flash fixation or heat roll fixation or a combination thereof in a toner fixing process. By way of a preferable example, formation of an electrostatic latent image by image exposure can be carried out after uniformly charging the surface of a photoconductive insulator such as a photosensitive drum with a positive or negative electrostatic charge, by partially erasing the electrostatic charge deposited on the insulator by irradiating the photoconductive insulator with light in the pattern of the image with any of various means, thereby leaving the electrostatic latent image remaining. For example, the surface charge can be erased from particular portions by irradiating with laser beam, so as to form the electrostatic latent image on the photoconductive insulator according to the image information.

Then, the electrostatic latent image thus formed is visualized by development. This can be done by depositing the fine powder of the developing agent, which includes the toner of the present invention, on the latent image portion where the electrostatic charge remains on the photoconductive insulator.

After the developing step, the visualized image is transferred onto the recording medium. This can generally be done by electrostatically transferring the toner image onto a recording medium such as recording paper.

Finally, the toner image transferred in the transfer step described above is melted and fixed on the recording medium by the flash fixing system according to the present invention. Thus, an intended duplicate such as print or the like is obtained through the series of processes described above.

The method of forming images based on electrophotography is well known in this technical field and accordingly description thereof will be omitted herein.

The image forming apparatus of the present invention, typically the electrophotographic apparatus, is also well known in this technical field and accordingly description thereof will be omitted herein. For reference, an example of an electrophotographic apparatus which can be advantageously used in the present invention is shown in FIGS. 1 and 2.

The electrophotographic apparatus shown in FIG. 1 is an apparatus which employs a flash fixing system. In the electrophotographic apparatus, a developing agent 11 prepared by mixing the toner of the present invention and a carrier are stirred with a stirring screw 12 so as to effect friction charging. The developing agent 11 which is charged by friction is guided through a predetermined circulation path via a developing roller 13 to reach a photosensitive drum 14. The photosensitive drum 14 may be constituted from a photosensitive material which has photoconductivity, for example, an organic photosensitive material such as polysilane, phthalocyanine, phthalopolymethine or an inorganic photosensitive material such as selenium and amorphous silicon, or an insulating material, depending on the method of forming the latent image.

The surface of the photosensitive drum 14 which has received the developing agent 11 transferred thereto is electrostatically charged by a preliminary charger 15 located behind the drum in the rotating direction thereof, while the electrostatic latent image is formed thereon by the light applied by an exposure device (not shown) according to the image. The preliminary charger 15 may comprise a corona discharging mechanism such as a corotron or scorotron, or a contact charging mechanism such as a brush charger. The exposure device may be constituted by using various optical systems as the light source, such as a laser optical system, an LED optical system or a liquid crystal optical system. Thus, the developing agent 11 which has been charged and transferred to the photosensitive drum 14 is deposited on the drum surface in the area of electrostatic latent image, thereby forming the visualized toner image.

The toner image 11 formed on the photosensitive drum 14 is moved onto the transfer section 16 and is transferred onto a recording medium (paper, film, etc.) 21. The transfer section 16 may have various constitutions depending on the type of force used in the transfer process, such as electrostatic force, mechanical force or viscous force. In the case where electrostatic force is used, for example, a corona transferring device, a roll transferring device, a belt transferring device or the like can be employed.

The recording medium 21 is guided in the direction of arrow shown in the drawing, so that the toner image is fixed thereon below the flash fixing device 18. The toner image on the recording medium 21 is heated by the flash fixing device 18 so as to melt and penetrate into the recording medium 21 thereby to be fixed. When the fixing step is completed, a fixed image 22 is obtained.

Toner which is left without being used in the transfer step in the toner image 11 on the photosensitive drum 14 is decharged by a decharger (not shown) and removed from the surface of the photosensitive drum 14 by a cleaning device (a blade in the illustrated case) 17. The cleaning device may be, besides a blade, a magnetic brush cleaner, an electrostatic brush cleaner or a magnetic roller cleaner.

The electrophotographic apparatus shown in FIG. 2 is the same as that shown in FIG. 1, except for using a heat roll fixing device 19 in place of the flash fixing device.

The present inventors have found that the toner of the present invention can advantageously be used commonly with both the flash fixing system and the heat roll fixing system. According to the toner of the present invention, regardless of the fixing system employed, excellent printing characteristics can be obtained by utilizing the advantages of each fixing system. If desired, an electrophotographic printer equipped with both the flash fixing mechanism and the heat roll fixing mechanism may be provided. In such a case, the flash fixation is carried out on the recording medium such as recording paper, followed by a heat roll fixation within a short time after completion of the flash fixation, so that the printing density is improved, or high printing density is realized with a small amount of the toner deposited.

### EXAMPLES

The following examples further illustrate the present invention in detail. It should be noted, however, that the present invention is not limited to these examples.

### Example 1

Preparation of Toner 1

The following components were prepared in the ratio shown below. The bisphenol A monomer was used in different amounts, as shown in Table 1 below.

| | | |
|---|---|---|
| Binder resin | Urethane-modified polyester resin, | 85% by |
| | XPE2118 (trade name, manufactured by | weight |
| | Mitsui Chemicals) | |
| Colorant | Furnace Carbon, Mogal L (manufactured | 10% by |
| | by Cabot) | weight |
| Fixing | Bisphenol A monomer (melting point: | |
| auxiliary | 160° C., manufactured by Wako Pure | |
| | Chemical Industries, Ltd.) | |
| Charge | Azo dye, T-95 (trade name, manufactured | 0.5% by |
| controlling | by Hodogaya Chemical CO., Ltd.) | weight |
| agent | | |
| Wax | Polypropylene wax, Biscoal 660-P (trade | 4% by |
| | name, manufactured by Sanyo Chemical | weight |
| | Industries, Ltd.) | |

These components were mixed with stirring in a ball mill and then the mixture was melted and kneaded in an extruder PCM-45 (trade name, manufactured by IKEGAI CORPORATION) heated to 140° C. After cooling the kneaded mixture for it to solidify, the solid mixture was ground by a Rotoplex coarse grinder and then ground into fine powder in a jet mill L-2 (manufactured by DAIICHI JITSUGYO CO., LTD.). The fine powder thus obtained was classified by an air flow classifier (manufactured by Alpine Co.), thereby to obtain fine spherical particles having a volume-average particle diameter of 8.5 μm. To the fine particles of toner thus obtained, 0.5% by weight of silica particles H2000/4 (trade name, manufactured by Clariant Japan Co., Ltd.) were externally added in a super mixer (manufactured by Kawata Mfg.). The resulting toner containing silica, as an external additive, in the form of fine particles is referred to as “toner 1” hereinafter.

### Example 2

Preparation of Toner 2

The following components were prepared in the ratio shown below. The bisphenol A monomer was used in different amounts, as shown in Table 1 below.

| | | |
|---|---|---|
| Binder resin | Polyester resin, FN119 (trade | 85% by weight |
| | name, manufactured by Kao | |
| | Corp.) | |
| Colorant | Furnace Carbon, Mogal L | 10% by weight |
| | (manufactured by Cabot) | |
| Fixing | Bisphenol A monomer (melting | |
| auxiliary | point: 160° C., manufactured by | |
| | Wako Pure Chemical Industries, | |
| | Ltd.) | |
| Charge | Azo dye, T-95 (trade name, | 0.5% by weight |
| controlling | manufactured by Hodogaya | |
| agent | Chemical CO., Ltd.) | |
| Wax | Polypropylene wax, Biscoal 660- | 4% by weight |
| | P (trade name, manufactured by | |
| | Sanyo Chemical Industries, | |
| | Ltd.) | |

These components were mixed with stirring in the same manner as in Example 1, and then the mixture was melted and kneaded. After the resulting kneaded mixture was solidified by cooling in the same manner as in Example 1, the solid mixture was ground into fine powder and then classified, thereby to obtain fine spherical particles having a volume-average particle diameter of 8.5 μm. To the fine particles of toner thus obtained, 0.5% by weight of silica particles H2000/4 (trade name, manufactured by Clariant Japan Co., Ltd.) were externally added in a super mixer in the same manner as in Example 1. The resulting toner containing silica, as an external additive, in the form of fine particles is referred to as “toner 2” hereinafter.

### Example 3

Preparation of Toner 3

The following components were prepared in the ratio shown below. The bisphenol A monomer was used in different amounts as shown in Table 1 below.

| | | |
|---|---|---|
| Binder resin | Styrene-acrylic resin, UN13000 | 85% by weight |
| | (trade name, manufactured by | |
| | Sanyo Chemical Industries, Ltd.) | |
| Colorant | Furnace Carbon, Mogal L | 10% by weight |
| | (manufactured by Cabot) | |
| Fixing | Bisphenol A monomer (melting | |
| auxiliary | point: 160° C., manufactured by | |
| | Wako Pure Chemical Industries, | |
| | Ltd.) | |
| Charge | Azo dye, T-95 (trade name, | 0.5% by weight |
| controlling | manufactured by Hodogaya | |
| agent | Chemical CO., Ltd.) | |
| Wax | Polypropylene wax, Biscoal 660-P | 4% by weight |
| | (trade name, manufactured by | |
| | Sanyo Chemical Industries, Ltd.) | |

These components were mixed with stirring in the same manner as in Example 1, and then the mixture was melted and kneaded. After the resulting kneaded mixture was solidified by cooling in the same manner as in Example 1, the solid mixture was ground into fine powder and then classified, thereby to obtain fine spherical particles having a volume-average particle diameter of 8.5 μm. To the fine particles of toner thus obtained, 0.5% by weight of silica particles H2000/4 (trade name, manufactured by Clariant Japan Co., Ltd.) were externally added in a super mixer in the same manner as in Example 1. The resulting toner containing silica, as an external additive, in the form of fine particles is referred to as “toner 3” hereinafter.

### Example 4

Printing Test

To evaluate the flash fixability with respect to (1) fixability of the toner and (2) occurrence of voids (occurrence of white defects), a printing test was carried out by way of the following procedure, using the toners 1 to 3 prepared in Examples 1 to 3.

Each toner and each carrier was mixed in a mixing ratio of (4.0% by weight):(96% by weight). The carrier used herein is one obtained by coating a Sr—Mn ferrite core (manufactured by Powdertech Co., Ltd.) with 1.0% by weight of a silicone resin SR2410 (trade name, manufactured by DOW CORNING TORAY SILICONE CO., LTD.) while being evacuated, using a universal stirrer.

After converting a high-speed printing machine (F6762D, manufactured by Fujitsu) designed for flash fixation to one for negatively charged toner, solid images of 1 inch square (2.5 cm×2.5 cm) were printed at a process speed of 1,200 mm per second on plain paper used as the recording medium. The energy of the fixing light was 1.7 J/cm² and the duration of one flash cycle was 1000 μ/s. Using the following procedure, the prints thus obtained were observed to determine the fixation ratio of the toner and to determine whether voids (white defects) were generated or not.

(1) Measurement of Fixation Ratio of Toner

The optical density of the solid image portions printed on the paper was measured first. Then, after lightly sticking an adhesive tape (Scotch™ Mending Tape manufactured by Sumitomo 3M) on the solid image portions printed on the same paper, a cylinder made of steel 100 mm in diameter and 20 mm in width was rolled over the tape in contact therewith, and then the tape was pulled off the paper. Thereafter, the optical density of the solid image portions printed on the paper from which the tape was removed was measured again. Optical densities before and after removing the tap were compared and the ratio of the optical densities which is referred herein to “fixing ratio (%)” was used to evaluate fixability of the toner. Prints with a fixation ratio of 95% or more can be rated as having good fixability.

The measurement results obtained are shown in Table 1 below and plotted in FIG. 3. In FIG. 3, the toner 1 corresponds to the curve I, the toner 2 corresponds to the curve II, and the toner 3 corresponds to the curve III.

TABLE 1

| Amount of bisphenol | | | |
|---|---|---|---|
| A monomer (% by | | | |
| weight) | Toner 1 | Toner 2 | Toner 3 |
| 0 | 20 | 25 | 15 |
| 0.1 | 40 | 50 | 25 |
| 0.2 | 80 | 90 | 30 |
| 0.5 | 90 | 95 | 45 |
| 1 | 95 | 100 | 80 |
| 5 | 100 | 100 | 90 |
| 10 | 100 | 100 | 95 |
| 20 | 100 | 100 | 100 |
| 50 | 100 | 100 | 100 |
| 80 | 100 | 100 | 100 |
| 90 | 100 | 100 | 100 |
| 95 | 100 | 100 | 100 |

(2) Evaluation of Void (White Defect)

Solid image portions printed on the paper were observed with an optical microscope, to visually determine whether white defects were generated or not. As a result, it was determined that remarkable and thus unacceptable white defects, due to presence of a large numbers of voids, occurred when the amount of the bisphenol A monomer was 95% by weight.

### Example 5

Printing Test

To evaluate the heat roll fixability with respect to (1) heat roll fixability of the toner and (2) occurrence of the offset phenomenon, a printing test was carried out by way of the following procedure, using the toners 1 to 3 prepared in Examples 1 to 3.

Each toner and each carrier was mixed in a mixing ratio of (4.0% by weight):(96% by weight). The carrier used herein is obtained by coating a Sr—Mn ferrite core (manfactured by Powdertech Co., Ltd.) with 1.0% by weight of a silicone resin SR2410 (trade name, manfactured by DOW CORNING TORAY SILICONE CO., LTD.) while being evacuated, using a universal stirrer.

Using a printing machine for heat roll fixing (VSP4700, manufactured by Fujitsu), solid images of 1 inch square (2.5 cm×2.5 cm) were printed at a fixing temperature of 160° C. on plain paper used as the recording medium. Using the following procedure, the prints thus obtained were observed to determine the fixation ratio of the toner and to determine whether offset had or had not occurred.

(1) Measurement of Fixation Ratio of Toner

In the same manner as in Example 4, the fixation ratio of the toner was measured. The results obtained are shown in Table 2 and plotted in FIG. 4. In FIG. 4, the tone 1 corresponds to the curve I, the toner 2 corresponds to the curve II, and the toner 3 corresponds to the curve III.

TABLE 2

| Amount of bisphenol | | | |
|---|---|---|---|
| A monomer (% by | | | |
| weight) | Toner 1 | Toner 2 | Toner 3 |
| 0 | 10 | 10 | 10 |
| 0.1 | 35 | 55 | 25 |
| 0.2 | 75 | 80 | 55 |
| 0.5 | 90 | 95 | 80 |
| 1 | 95 | 100 | 85 |
| 5 | 100 | 100 | 90 |
| 10 | 100 | 100 | 95 |
| 20 | 100 | 100 | 100 |
| 50 | 100 | 100 | 100 |
| 80 | 100 | 100 | 100 |
| 90 | 100 | 100 | 100 |
| 95 | 100 | 100 | 100 |

For reference, the printing test was carried out in the same manner as described above, except that the fixing temperature was changed to 150° C. from 160° C. As a result, only the fixation ratio, which is about 10% lower than the results described in Table 2, was obtained.

(2) Evaluation of Offset

Each solid image portion of the resulting prints was visually evaluated. As a result, it was determined that remarkable and thus unacceptable offset occurred when the amount of the bisphenol A monomer was more than 50% by weight.

### Example 6

Preparation of Toner A (for Comparison)

For comparison, a toner with the same composition as that of the toner 2 was prepared in the same manner as in Example 2. In this example, however, the same amount of an imide compound represented by the following formula was used in place of the bisphenol A monomer (1% by weight) used as the fixing auxiliary.

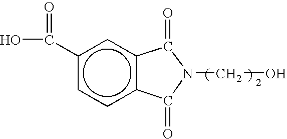

The resulting toner containing silica, as an external additive, in the form of fine particles is referred to as “toner A”, hereinafter.

Printing Test

To evaluate continuous printability, a printing test was carried out by way of the following procedure, using the toner 2 (the content of the bisphenol A monomer is 1% by weight) prepared in Example 2 and the toner A prepared as described above.

The toner and the carrier were mixed in a mixing ratio of (4.0% by weight):(96% by weight). The carrier used herein is one obtained by coating a Sr—Mn ferrite core (manufactured by Powdertech Co., Ltd.) with 1.0% by weight of a silicone resin SR2410 (trade name, manufactured by DOW CORNING TORAY SILICONE CO., LTD.) while being evacuated, using a universal stirrer.

After converting a high-speed printing machine (F6762D, manufactured by Fujitsu) designed for flash fixation to one for negatively charging toner, solid images of 1 inch square (2.5 cm×2.5 cm) were continuously printed at a process speed of 1,200 mm per second on plain paper used as the recording medium. The energy of the fixing light was 1.7 J/cm² and the duration of one flash cycle was 1000 μ/s.

As a result, it was found that good printing characteristics could be maintained even after printing one or more million sheets in the case of continuous printing using the toner 2. On the other, in the case of continuous printing using the toner A, the toner was spent on the carrier to cause filming of the toner after printing of 500,000 sheets, thereby staining the background portion of the printing paper. To confirm the cause of the staining with toner, a filming component of the carrier was dissolved in methyl ethyl ketone and the resulting solution was inspected by infra-red spectrometry. As a result, it was found that the filming component was made of an imide compound which has an adverse effect on continuous printing.

Industrial Applicability

As described above, according to the present invention, the fixing strength of images can be significantly improved and the resulting electrophotographic toner can be used commonly with both the flash fixing system and the heat roll fixing system by incorporating a bisphenol A monomer into a toner. When used in any fixation system, the toner of the present invention can solve various prior art problems. The toner of the present invention can prevent the problem called voiding from occurring, and does not cause such problems as curling of the paper after fixing and staining of the paper by offset. Since the limitation to the fixation system was removed, it becomes possible to reduce numbers of toners to the lowest level, thus allowing mass production of the toner and reduction in production cost.

1. An electrophotographic toner comprising a bisphenol A monomer.

2. An electrophotographic toner according to claim 1, which contains the bisphenol A monomer in an amount within a range from 0.2 to 90% by weight based on the total weight of the toner.

3. An electrophotographic toner according to claim 1, which contains a styrene-acrylic resin, a polyester resin or a mixture thereof as a binder resin.

4. A method of forming an image on a recording medium by means of an electrophotographic system, which comprises the steps of forming an electrostatic latent image by image exposure, visualizing the electrostatic latent image by development, transferring the visualized image onto the recording medium and fixing the transferred image, wherein
a developing agent containing an electrophotographic toner, which comprises a bisphenol A monomer, is used in the developing step of the electrostatic latent image, and
either a flash fixing system or a heat roll fixing system is used as the toner fixing method in the step of fixing the image after transferring the image, which has been visualized by the use of the developing agent, onto the recording medium.

5. An image forming method according to claim 4, wherein a developing agent, which contains a styrene-acrylic resin, a polyester resin or a mixture thereof as a binder resin of the toner and also contains a bisphenol A monomer in an amount within a range from 0.2 to 90% by weight based on the total weight of the toner, is used in the developing step of the electrostatic latent image.

6. An image forming method according to claim 5, wherein the flash fixing system is employed in the step of fixing the image after transferring the image, which has been visualized by the use of said developing agent, onto the recording medium, with the energy of flashlight being set within a range from 0.5 to 3.0 J/cm² and duration of the flashlight being set within a range from 500 to 3,000 μ/s.

7. An image forming method according to claim 5, wherein the heat roll fixing system is employed in the step of fixing the image after transferring the image, which has been visualized by the use of the developing agent, onto the recording medium, while the temperature of the heat roll surface is regulated, in average, to a temperature higher than the melting point of the bisphenol A monomer.
